(19) United States
(12) Patent Application Publication
(10) Pub. No.: US 2014/0155155 A1
(43) Pub. Date: Jun. 5, 2014

(54) INTEGRATED ONLINE GAMING PORTAL OFFERING ENTERTAINMENT-RELATED CASUAL GAMES AND USER-GENERATED MEDIA

(71) Applicant: Exponential Entertainment, Inc., Seattle, WA (US)

(72) Inventors: William Kuper, Seattle, WA (US); David M. Long, Issaquah, WA (US); Kelly Long, Issaguah, WA (US); Ryan Ciociola, North Andover, MA (US); Dana Hogenson, Seattle, WA (US); Steve Sullivan, Bainbridge Island, WA (US)

(21) Appl. No.: 13/922,659

(22) Filed: Jun. 20, 2013

Related U.S. Application Data
(63) Continuation of application No. 12/831,862, filed on Jul. 7, 2010, now abandoned.
(60) Provisional application No. 61/224,022, filed on Jul. 8, 2009.
(60) Provisional application No. 61/252,615, filed on Oct. 16, 2009.
(60) Provisional application No. 61/265,342, filed on Nov. 30, 2009.
(60) Provisional application No. 61/291,687, filed on Dec. 31, 2009.

(51) Int. Cl. A63F 13/30

(52) U.S. Cl. CPC A63F 13/12
USPC 463/31

(57) ABSTRACT

An integrated online gaming portal offers entertainment-related casual games and/or user-generated media. The integrated online gaming portal offers a variety of features, including media-based casual games, casual games featuring user-generated content, and a media-based horoscope. Media is received from a variety of sources, including TV and movie studios, actors/actresses, sponsors, and the user him- or herself. A media-integrated game is generated by incorporating the received media into a portal game, and a user is provided with access to the generated game. In some embodiments, the generated game is hosted by the portal server, while in other embodiments the generated game is downloaded to a computer or mobile device of the user.

### CROSS-REFERENCE TO RELATED APPLICATION(S)

This application is a continuation application of U.S. patent application Ser. No. 12/831,862 filed on Jul. 7, 2010 (attorney docket no. 67222-8003.US07), which claims the benefit of U.S. Provisional Patent Application Ser. No. 61/224,022 filed on Jul. 8, 2009 (attorney docket no. 67222-8003US3); U.S. Provisional Patent Application Ser. No. 61/252,615 filed on Oct. 16, 2009 (attorney docket no. 67222-8003US4); U.S. Provisional Patent Application Ser. No. 61/265,342 filed on Nov. 30, 2009 (attorney docket no. 67222-8003US5); and U.S. Provisional Patent Application Ser. No. 61/291,687 filed on Dec. 31, 2009 (attorney docket no. 67222-8003US6). The disclosures of each of these applications are hereby incorporated herein by reference in their entireties.

### BACKGROUND

Computer games of all types are ubiquitous. Computer games range from complex video games to casual games, and many games in between. Casual games are generally characterized by relatively straightforward rules and the ability to play a game in a reasonably short period of time. Casual games include games such as solitaire, bingo, concentration, checkers, and a variety of other games. Casual games may be played on computers, the Internet, game consoles, and other platforms.

Because of the prevalence of casual and other computer games, providing novel and creative games is a desirable objective for game developers and providers alike, as they seek to attract and maintain many users.

### BRIEF DESCRIPTION OF THE DRAWINGS

FIG. 1 is a block diagram of a basic and suitable computer that may employ aspects of the described technology.

FIG. 2 is a block diagram illustrating a simple, yet suitable system in which aspects of the described technology may operate in a networked computer environment.

FIG. 3 is a schematic diagram of embodiments of an online gaming portal home page.

FIG. 4 is a display diagram illustrating embodiments of an online gaming portal home page.

FIG. 5 is a schematic diagram of embodiments of a media-based horoscope.

FIG. 6 is a flow diagram of a suitable process for displaying a media-based horoscope.

FIG. 7 is a display diagram illustrating a text horoscope.

FIG. 8 is a display diagram illustrating a media-based clip associated with a horoscope.

FIG. 9 is a display diagram illustrating an opportunity to purchase or rent media corresponding to a media-based clip.

FIG. 10 is a schematic diagram of embodiments of an area of an online gaming portal that features one or more actors and/or actresses.

FIG. 11 is a schematic diagram of embodiments of an area of an online gaming portal that includes content on which users can wager.

FIG. 12 schematic diagram of embodiments of an area of an online gaming portal in which users can create their own custom media clips.

FIG. 13 is a schematic diagram of embodiments of a points redemption area of an online gaming portal.

FIG. 14 is a schematic diagram of embodiments of an area of an online gaming portal that includes a variety of casual games.

FIG. 15 is a block diagram of a suitable system for generating a game incorporating media from one or more media sources.

FIG. 16 is a flow diagram of a suitable process for generating a game incorporating media from one or more media sources.

FIG. 17 is a display diagram illustrating embodiments of an online gaming portal game.

FIG. 18 is a display diagram illustrating embodiments of another online gaming portal game.

Note: the headings provided herein are for convenience and do not necessarily affect the scope or interpretation of the described technology.

### DETAILED DESCRIPTION

An integrated online gaming portal offers entertainment-related casual games and/or user-generated media. A casual game is a computer, video, and/or online game targeted at or used by a mass audience of casual gamers. Casual games can have any type of gameplay, and fit in any genre. Casual games are generally characterized by relatively straightforward rules and the ability to play a game in a reasonably short period of time, as compared to hardcore games that have multiple, complex rules and a extensive game play over multiple levels, often involving a long storyline. Most casual games allow a user to achieve a desired result under the rules of the casual game (e.g. to solve a puzzle) in under 5 to 15 minutes. In addition, casual games usually involve relatively low production and distribution costs for game producers and developers.

The integrated online gaming portal offers a variety of features, including, but not limited to, media-based casual games, incorporating user-generated content into casual games, and a media-based horoscope.

Media-based casual games are featured in a Player Arcade or other portal area. Media is received from a variety of media sources, including, but not limited to, one or more TV and movie studios, talent (i.e., actors and/or actresses), sponsors (i.e., advertisers), and the user him- or herself. A media-integrated game is generated by incorporating the received media into a portal game, and a user is provided with access to the generated game. In some embodiments, the generated game is hosted by the portal server, while in other embodiments the generated game is downloaded to a computer or mobile device of the user.

Media-based casual games include games that incorporate user-generated media. User-generated media generally includes personal media, although it may at times include licensed media or other media. Personal media includes personal photos, videos, and/or other media that exist locally on the user's computer and/or mobile device. Personal media also includes personal photos, videos, and/or other media that exist on a server repository accessible via the Internet, such as those provided by services including Flickr, Facebook, YouTube, and other services. Licensed media includes any form of media to which a game developer, game distributor, and/or portal host entity has a license. Licensed media often refers to copyrighted works where certain display or reproduction rights are granted to the game developer, game distributor, and/or portal host entity for sale or distribution to users. For example, licensed media may include digital images, video clips, audio clips, animations or other content from or related to the various Star Trek television shows or other copyrighted works under the Star Trek franchise owned and licensed by either CBS Inc. or Paramount Pictures/Viacom. A media-integrated game is generated by incorporating the received user-generated media into a portal game, and the user is provided with access to the generated game.

The integrated online gaming portal also features a media-based horoscope (the “Hollywood Horoscope”). The Hollywood Horoscope presents media associated with a user's birthday and/or astrological sign. The Hollywood Horoscope is accessible from a desktop widget, a portal web site, a mobile device, a game console, and/or in another manner. In response to receiving a user's birthday and/or astrological sign, a text version of the user's horoscope is displayed, in addition to a media-based clip corresponding to the text horoscope. The user is also presented with an opportunity to purchase or rent media associated with the media-based clip.

Various embodiments of the technology will now be described. The following description provides specific details for a thorough understanding and enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the described technology. Certain terms may even be emphasized below; however, any terminology intended to be interpreted in any restricted manner will be overtly and specifically defined as such in this Detailed Description section.

### A. Suitable Computing Environment

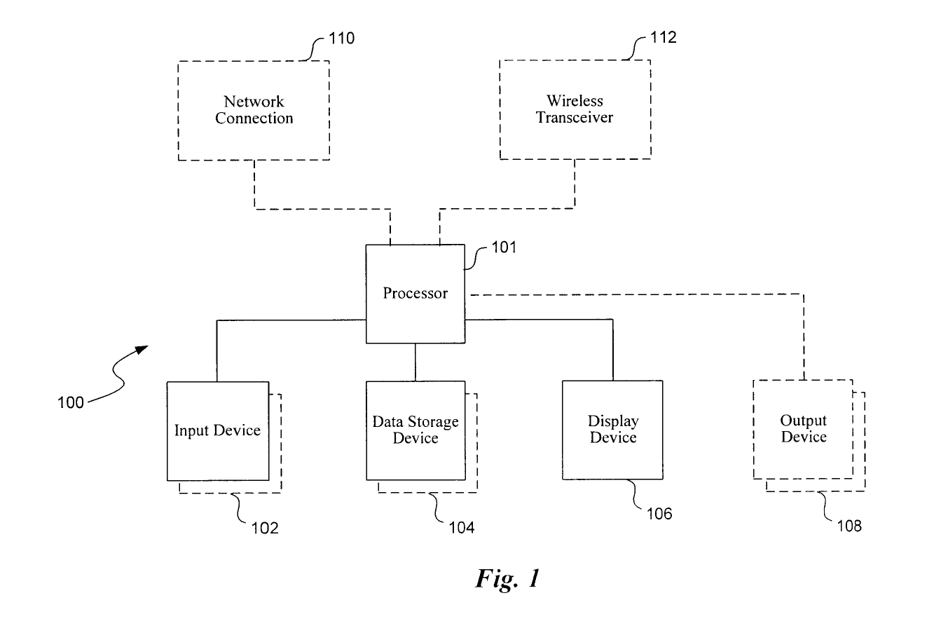

FIG. 1 and the following discussion provide a brief, general description of a suitable computing environment in which aspects of the described technology can be implemented. Although not required, aspects and embodiments of the technology will be described in the general context of computer-executable instructions, such as routines executed by a general-purpose computer, e.g., a server or personal computer. Those skilled in the relevant art will appreciate that the described technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The described technology can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor or any device capable of communicating with a network, including consumer electronic goods such as game devices, cameras, or other electronic devices having a processor and other components, e.g., network communication circuitry.

The described technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Aspects of the technology described herein may be stored or distributed on computer-readable media, including magnetic and optically readable and removable computer discs, stored as firmware in chips (e.g., EEPROM chips). Alternatively, aspects of the invention may be distributed electronically over the Internet or over other networks (including wireless networks). Those skilled in the relevant art will recognize that portions of the described technology may reside on a server computer, while corresponding portions reside on a client computer. Data structures and transmission of data particular to aspects of the described technology are also encompassed within the scope of the described technology.

Referring to FIG. 1, embodiments of the described technology employ a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN), or the Internet (not shown in FIG. 1).

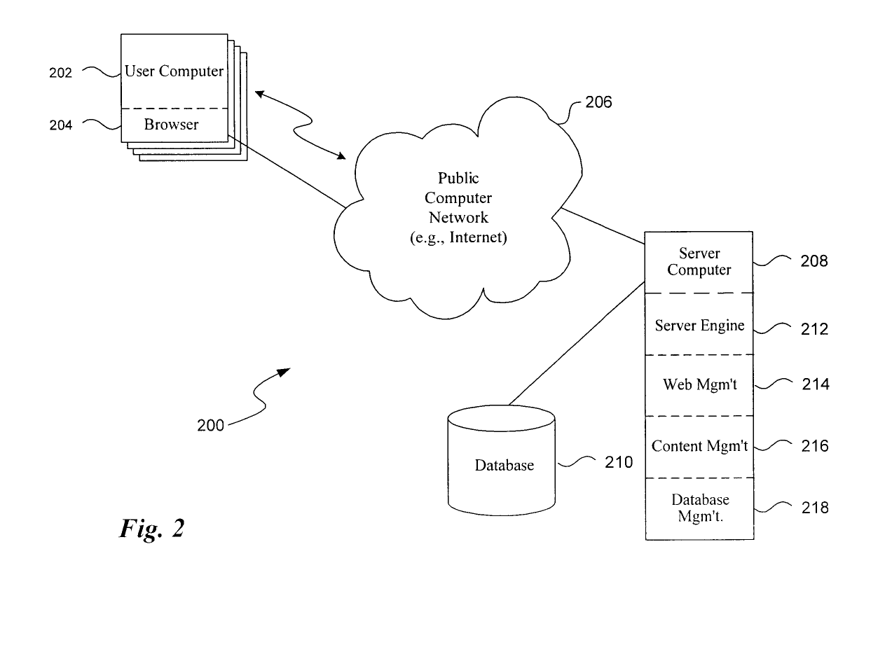

Aspects of the described technology may be practiced in a variety of other computing environments. For example, referring to FIG. 2, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs many or all of the functions for receiving, routing, and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216, and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data.

### B. Integrated Online Gaming Portal

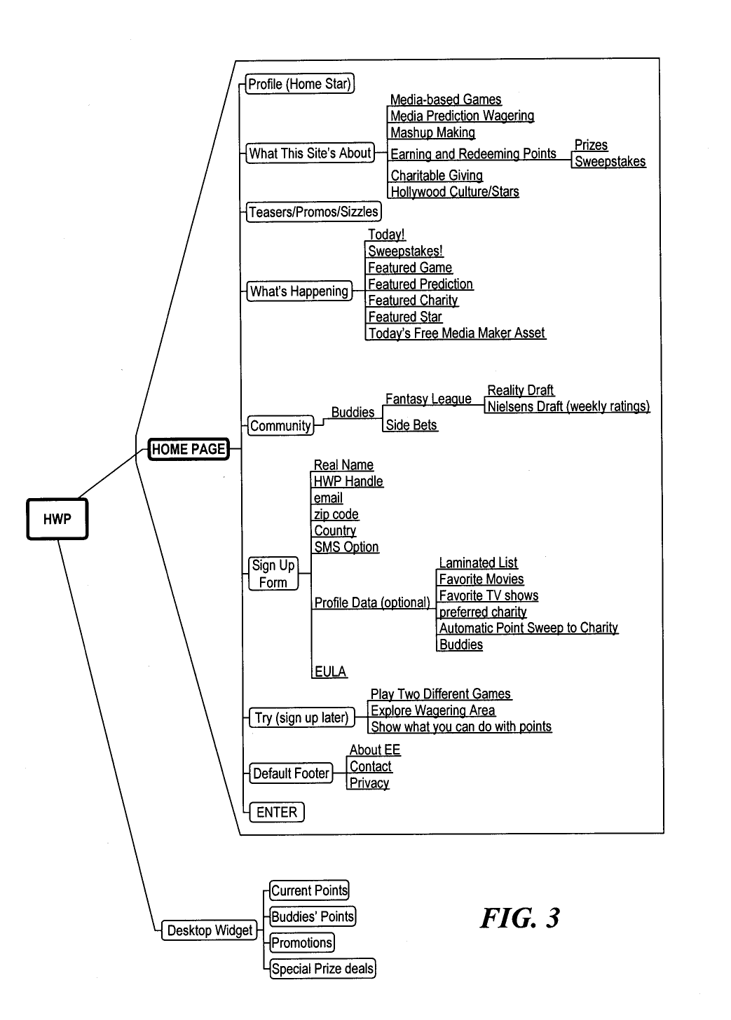

FIGS. 3, 5, and 10-14 illustrate suitable schematic diagrams that show web pages and navigation between web pages as implemented in whole or in part by the system described herein, its components, and/or its users. The various diagrams, as well as flowcharts and display diagrams in other Figures, are generally self-explanatory to persons of ordinary skill in the relevant art. Without sacrificing clarity, but for brevity, and to orient one skilled in the art as to the symbols and nomenclature employed therein, only certain portions of the following Figures will be discussed in detail. From the detailed discussions of certain portions and components in selected Figures, one skilled in the relevant art can readily understand the similar components or steps in the remaining Figures sufficient to understand and practice aspects of the described technology.

1. Home Page

In some embodiments, when a user accesses the portal, the user is initially presented with a portal home page. The home page can be primarily informational and directional, provide access to content, and/or serve a variety of other functions. FIG. 3 is a schematic diagram of embodiments of the home page. The home page enables the user to navigate to different sections of the portal, including, but not limited to:
Home Star—a user's customizable home page;
What This Site's About—descriptions of various aspects of the portal, including games, media prediction wagering, mashup maker, earning and redeeming points, charitable giving, and Hollywood stars;
Teasers, Promos, Sizzles—highlights portal content and games;
What's Happening—includes featured items, such as a featured game, sweepstakes, prediction, charity, and/or star;
Community—access buddies' names and profiles and/or enter a Fantasy League;
Sign Up Form—sign up for access to the portal and set user preferences; and
Sign Up Later—allows the user to play one or more teaser games, if the user does not currently wish to register.

In addition, the home page can include a variety of information commonly presented on a web site, such as links including “About,” “Company Contact Information,” and “Privacy Statement,” accessed from the “Default Footer” links from the home page. Further, the home page may be one of multiple different ways to access content for “HWP” or “Hollywood Player,” another being desktop widgets that permit users to access certain features, such as current point, promotions, etc.

a. Home Star

A Home Star is a user-customizable home page. In some embodiments, the Home Star is an initial web page presented to the user upon logging in to the portal. The Home Star is partially or fully customizable to display user-selected content and features.

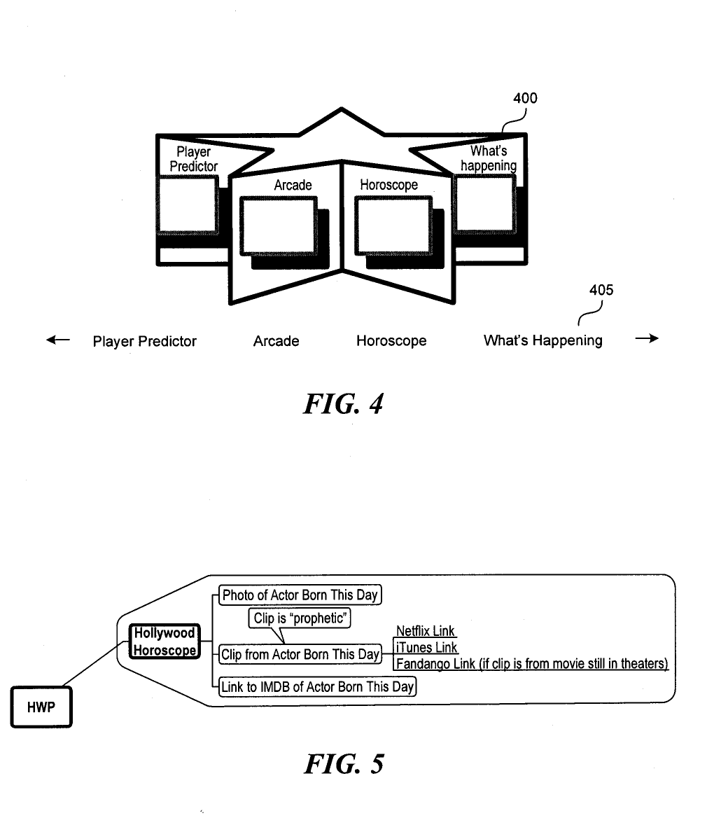

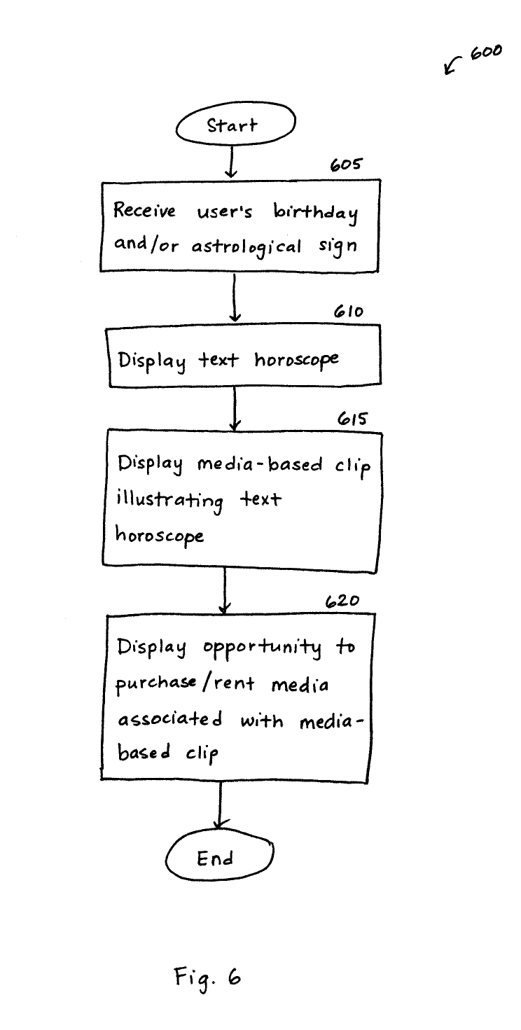

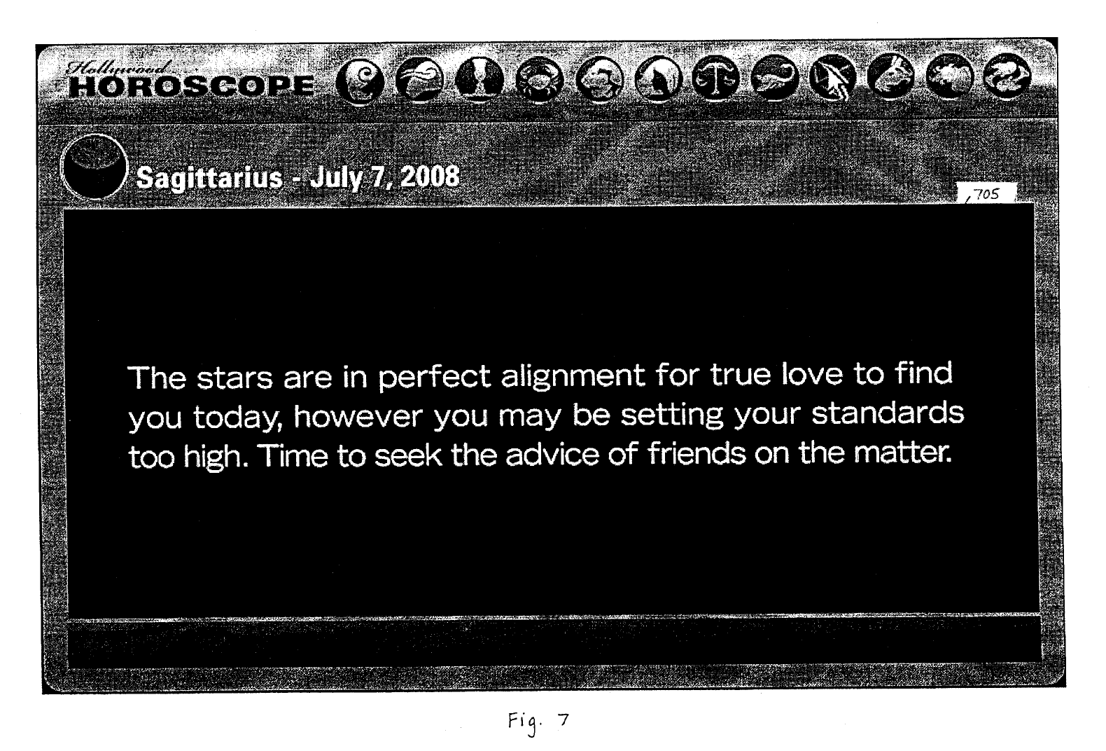

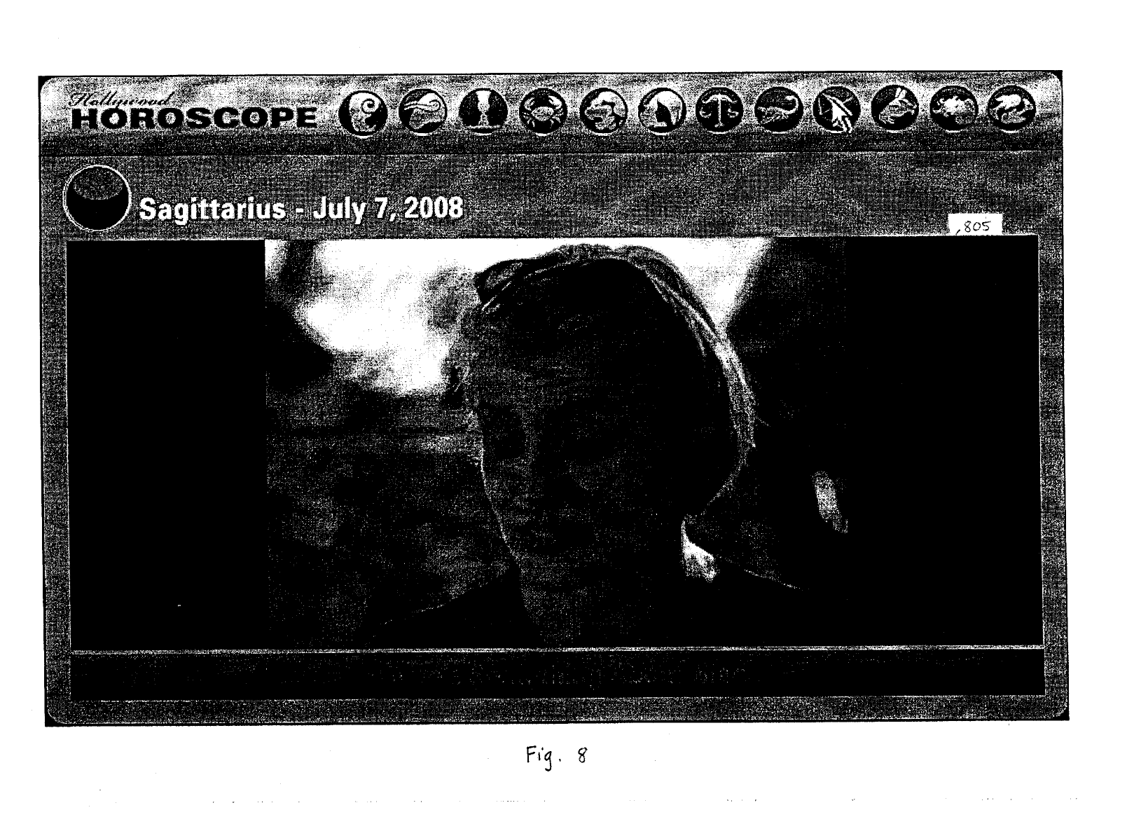

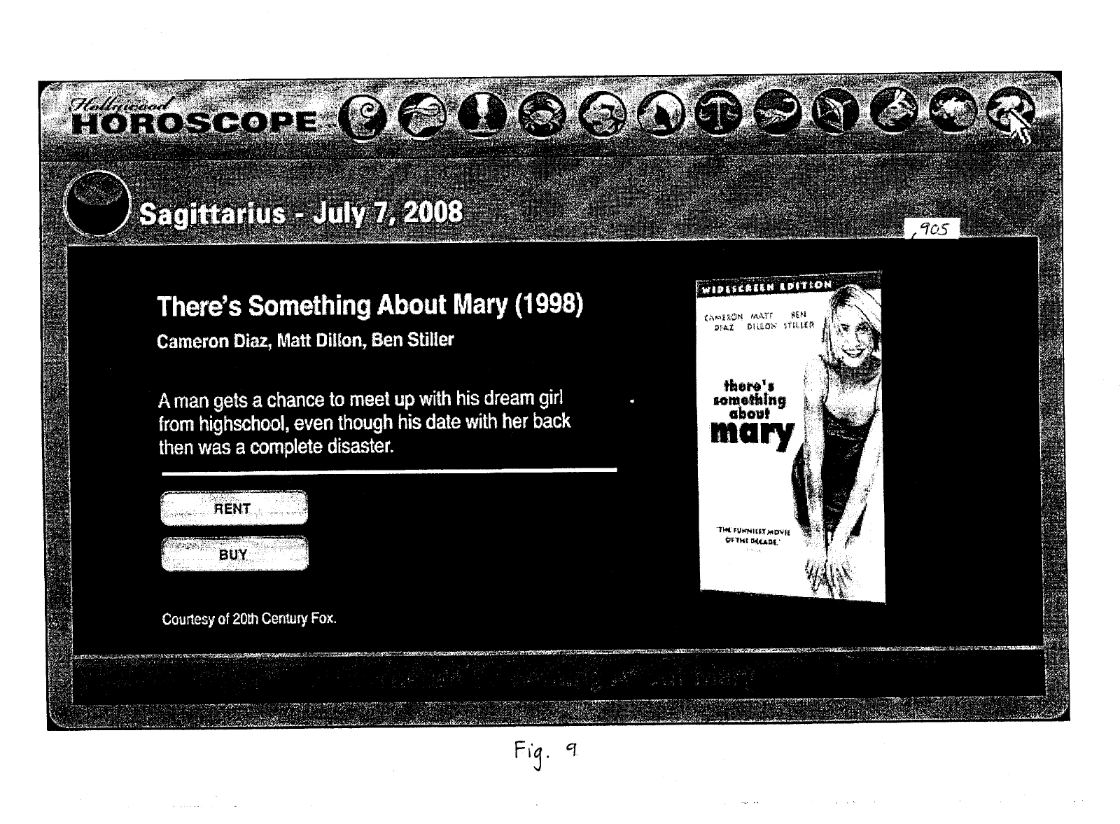

FIG. 4 is a display diagram depicting embodiments of the Home Star 400. One skilled in the art will appreciate that the Home Star 400 need not be in the shape of a star, and may have a variety of other shapes and/or forms. The Home Star 400 presents a variety of options associated with different web pages and/or portal areas, including, but not limited to: Player Predictor, Arcade, Horoscope, What's Happening, Current Wagers, Points Display/Karma Level, Favorites, Community, Buddy Lists/Fantasy Leagues, Chat/Blog, Message, Point/Prize Redemption/Donation, Walk of Fame, Player Maker, Customizable Facets, and other options.

As the user navigates around the facets of the Home Star 400, the Home Star 400 rotates to present additional options. The Home Star 400 can be presented using a variety of well known technologies, including Flash. The user can select an option from the Home Star 400 itself to navigate to a web page associated with the selected option. Alternatively or additionally, the player can select a standard HTML hyperlink 405 to navigate to an associated web page. As the user selects a standard HTML hyperlink 405, the Home Star 400 rotates to the corresponding selected option.

2. Hollywood Horoscope

The Hollywood Horoscope is a media-based horoscope that presents media associated with a user's birthday and/or astrological sign or that of another person. The Hollywood Horoscope is accessible from a desktop widget, the portal web site (e.g., a user's Home Star), a mobile device, a game console, and/or in another manner. A new Hollywood Horoscope may be presented on a periodic basis, such as daily, weekly, or monthly. FIG. 5 is a schematic diagram of embodiments of the Hollywood Horoscope.

FIG. 6 is a flow diagram of a suitable process for displaying the Hollywood Horoscope. At a block 605, a portal server receives the user's birthday and/or astrological sign. In some embodiments, the portal server retrieves the user's birthday from an associated database, while in other embodiments, the user selects an astrological sign or enter his birthday on a web page presented by the portal. For example, a user may have entered his birthday and/or astrological sign when he signed up for portal access. In response, the portal server can store the user's birthday and/or astrological sign in an associated database. Alternatively or additionally, the portal server can present the user with a web page that includes a drop-down menu, text entry field, or other mechanism by which the user can select or enter a birthday and/or astrological sign.

In some embodiments, the user can select another user's birthday and/or astrological sign in order to generate a Hollywood Horoscope for the other user. In such embodiments, the user can forward the Hollywood Horoscope and/or a link to the Hollywood Horoscope to the other user.

At a block 610, the portal displays a text version of a user's horoscope. FIG. 7 is a display diagram that depicts an example of a text horoscope 705 displayed to a user. As discussed above, the text horoscope 705 corresponds to the received birthday and/or astrological sign.

At a block 615, the portal displays a media-based clip that illustrates the text horoscope. The media-based clip can be a film clip, TV show clip, or any other video and/or audio clip that relates to the horoscope. FIG. 8 is a display diagram that depicts a media-based clip that is displayed to the user. The still image 805 depicted in FIG. 8 is intended to represent the media-based clip. One skilled in the art will appreciate that, in these and or other embodiments, the Hollywood Horoscope can display a still image, an animation, and/or other media. Alternatively or additionally, the Hollywood Horoscope can include a photo and/or one or more links associated with an actor that shares the user's birthday. These links may include links to the Internet Movie Database (imdb.com), Netflix, iTunes, Fandago, and other media web sites.

At a block, 620, the portal displays an opportunity to purchase or rent media associated with the media-based clip. FIG. 9 is a display diagram that depicts an opportunity that is displayed to the user to purchase or rent the media presented in the media-based clip depicted in FIG. 8. FIG. 9 includes details 905 about the media, such as film title, headlining actors and/or actresses, a brief description of the film, and an image that corresponds to the film. One skilled in the art will appreciate that other details about the media may also be displayed. In addition, FIG. 9 presents the user with the opportunity to purchase or rent the media, such as by selecting a “buy” or “rent” button. One skilled in the art will appreciate that other opportunities may be presented to the user in association with the media, including, but not limited to, opportunities to view, download, and/or stream the media.

One skilled in the art will appreciate that the blocks depicted in FIG. 6 (and in other Figures) can be performed in a different order, and that one or more blocks may be deleted, moved, added, subdivided, combined, and/or modified. For example, the media-based clip can be presented before the text horoscope. In addition, while the blocks are shown as being performed in series, these blocks may instead be performed in parallel, or may be performed at different times. For example, the media-based clip can be presented at the same time as the text horoscope.

3. Walk of Fame

The Walk of Fame is an area of the portal that features one or more actors and/or actresses. In some embodiments, a certain number of (e.g., four) actors and/or actresses are featured at a given time. The features actors and/or actresses can be changed on a periodic basis, e.g., once a day, week, month, or other period of time.

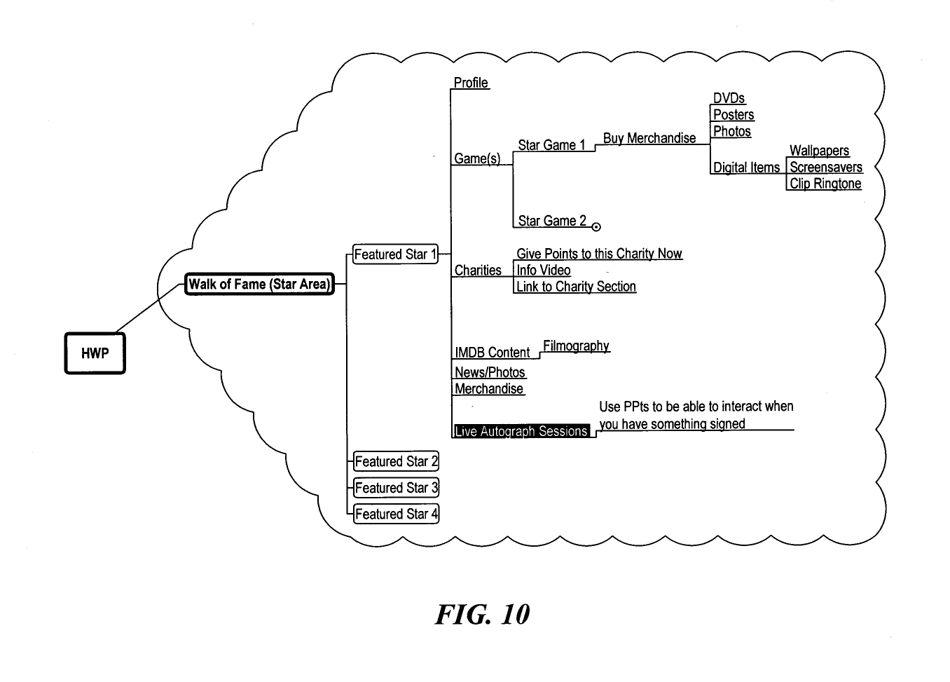

FIG. 10 is a schematic diagram of embodiments of the Walk of Fame. For a featured actor or actress, the Walk of Fame can include elements such as, but not limited to:
a Profile including the actor/actress's biography;
one or more Games featuring the actor/actress's likeness and/or works;
a Charity(ies) area including information on one or more charities that the actor/actress supports;
a Filmography area including a listing and/or details associated with the actor/actress's body of works;
a News area including news stories about the actor/actress;
a Photos area including photos of the actor/actress; and/or
a Merchandise area includes items including, but not limited to, DVDs, posters, photos, digital items (e.g., wallpapers, screen savers, clips, and ringtones), and other items.

Information for the featured actor/actress can be provided locally from one or more databases coupled to the portal and/or remotely from one or more third-party databases.

In some embodiments, the Walk of Fame periodically features one or more Virtual Live Autograph Sessions. During a session, an actor/actress is signing autographs at a location from which the actor/actress can be viewed via webcam. A user can have an item autographed and/or personalized by the actor/actress, and can view the actor/actress signing the user's item. For example, a user can have an item autographed by redeeming a certain number of points. During the session, the actor/actress can also discuss his/her current projects, a charity to which a donation will be made in accordance with users' redeemed points, answer questions submitted from users, and/or engage in other activities.

4. Player Predictor

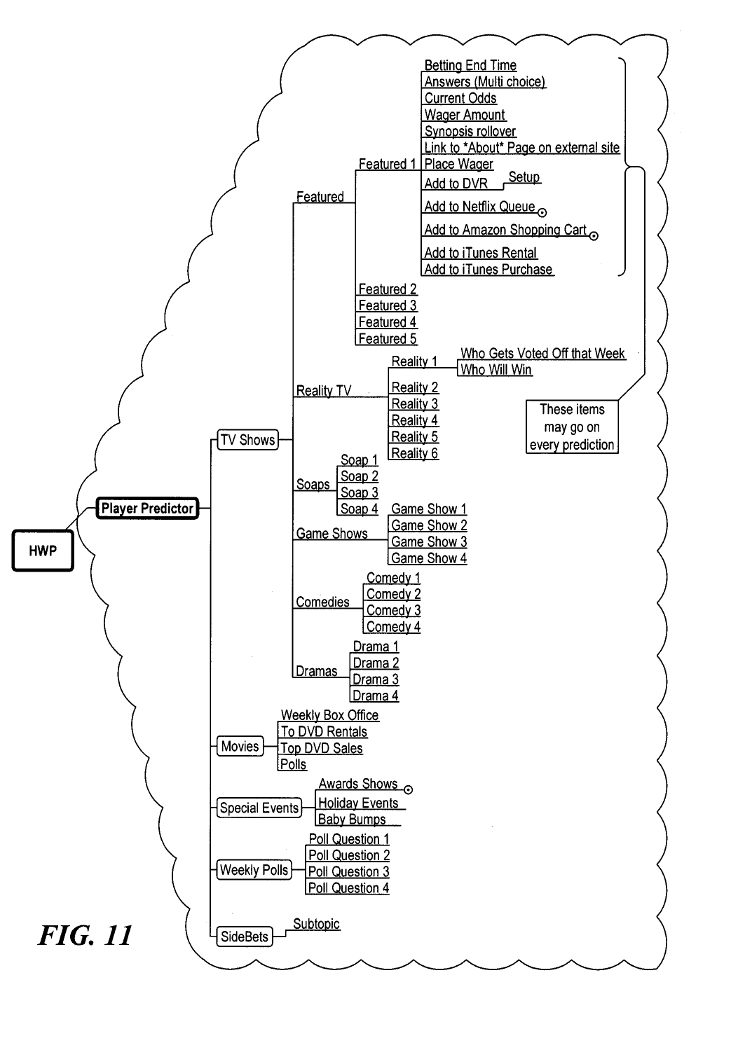

The Player Predictor includes a variety of content on which users can wager. For example, a user can wager on the outcome of a TV show and earn points for a correct prediction. FIG. 11 is a schematic diagram of embodiments of the Player Predictor. The content on which users can wager includes, but is not limited to, categories such as TV Shows, Movies, Special Events, Weekly Polls, Fantasy Leagues, and other content categories.

Once a user has selected content on which to wager, as discussed in additional detail herein, the user is presented with information including wager end time (e.g., the beginning time or a certain time prior to the beginning time of the relevant show), current odds, a synopsis of the wager, and merchandise options. In some embodiments, current odds change dynamically based on the number of wagers placed on an outcome. The synopsis of the wager includes an analysis of the current odds. Merchandise options include links that allow the user to purchase items associated with the relevant show, including a copy of the relevant show itself. These links may include links to Amazon.com, Netflix, iTunes, Fandago, and other media web sites. In addition, the Player Predictor solicits a wager amount from the user.

a. TV Shows

Each content category has a variety of subcategories of content. For example, TV Shows may include subcategories including Featured Content, Reality TV, Soaps, Game Shows, Comedies, Dramas, and/or other subcategories.

Featured Content includes one or more featured TV shows on which a user can wager. In some embodiments, Featured Content offers the user advantages over standard content. These advantages include, but are not limited to, higher odds, enhanced prizes, and/or other advantages. Accordingly, a content provider (e.g., TV studio) can promote certain content through premium placement.

Reality TV includes one or more reality-based TV shows on which a user can wager. For example, these reality TV shows may include Survivor, America's Next Top Model, American Idol, and/or other reality TV shows. Wagers can vary based on the format of the reality TV show. For example, a user can wager on a contestant who will be voted off the show next, who will win the show, and other circumstances and/or events.

Similarly, Soaps includes one or more soap operas on which a user can wager. Wagers can be based on various show outcomes, such as which character will suffer from amnesia this week. Games includes one or more game shows on which a user can wager. Wagers can be based on various show outcomes. For example, for the show Deal or No Deal, a user may wager on which briefcase will contain a million dollars.

Comedies includes one or more comedy shows on which a user can wager. Wagers can be based on various show outcomes. For example, for the show Two and a Half Men, a user may wager on how many women Charlie will date on the current episode. As another example, for The Office, a user may wager on how many times Michael will call a staff meeting this week.

Dramas include one or more drama shows on which players can wager. Wagers can be based on various show outcomes. For example, for Heroes, a user may wager on which character will be killed off this week. As another example, for the show CSI: Miami, a user may wager on how many times the actor David Caruso will take off his sunglasses this week.

b. Movies

Movies include one or more movie-related outcomes on which a user can wager. For example, a user may wager on which films will be in the weekly top box office. As another example, a user may wager on how many times James Bond will drink a martini in the new Bond film.

Movies may include a variety of subcategories, such as Comedies, Dramas, Classics, and other subcategories.

c. Special Events

Special Events include one or more celebrity events on which a user can wager. For example, a user may wager on one or more winners at an awards show, the day on which a celebrity's baby will be born, and other events.

d. Weekly Polls

Weekly Polls include questions for users, such as “Who is your favorite leading man?,” “Who is your favorite action hero?,” and other questions. A user can wager on the outcome of a poll question.

e. Fantasy League

Fantasy Leagues enable users to create and/or join a fantasy league in which they can compete against other users. In some embodiments, a user is charged a fee or must redeem a certain number of points in order to join a fantasy league.

5. Player Maker

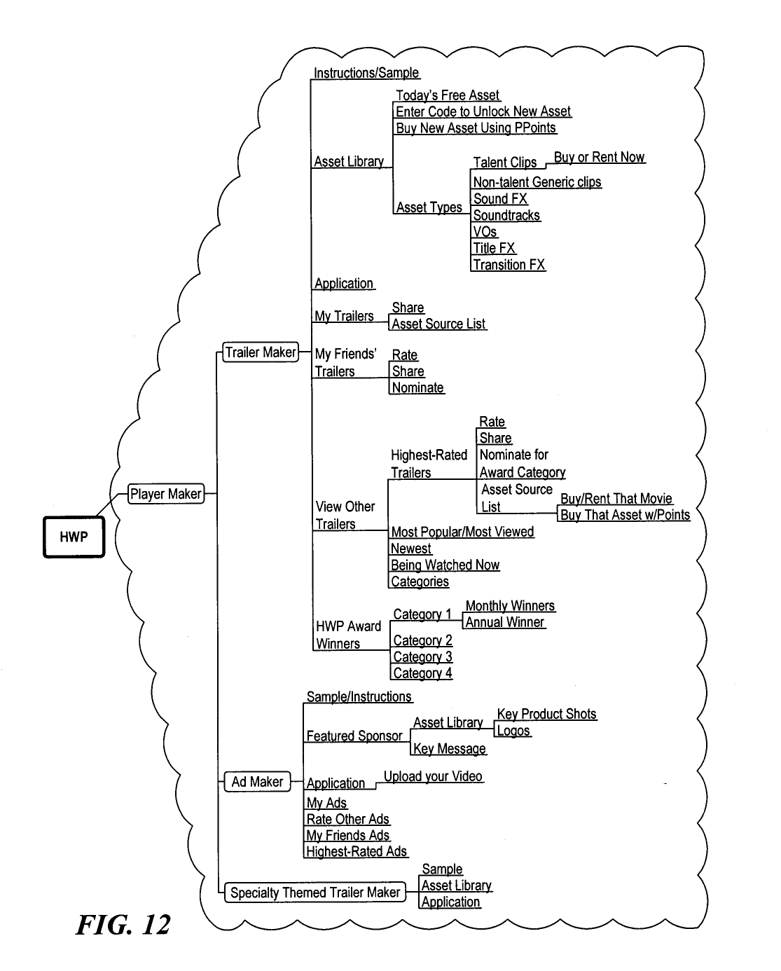

The Player Maker enables the user to create his or her own custom media clips—such as movie trailers, commercials, and other media—using a variety of digital media clips including, but not limited to, video, audio, and music clips. FIG. 12 is a schematic diagram of embodiments of the Player Maker.

A variety of media clips, including video, audio, and music clips are presented to the user. In some embodiments, the presented media clips are organized, such as by the use of tabs. Such an arrangement enables the user to more easily identify and select presented media clips. Tabs and/or other organizational mechanisms may be organized by type of media clip, such as Sound Effects, Soundtracks, Voice Overs, Titles, Transitions, and other types of media clips.

In some embodiments, a presented media clip is associated with a promotional mark, such as a “Buy/Rent Now” button. When a user selects a promotional mark, the user is directed to a web site through which the user can purchase or rent the associated media. For example, the user may be directed to Amazon.com, Netflix, iTunes, Fandango, or another media web site.

The user creates a custom media clip by selecting and arranging the presented media clips. In some embodiments, the user creates the custom media clip via a drag-and-drop interface. The user drags a presented media clip to a custom media clip area, and can rearrange clips as desired. In some embodiments, the custom media clip area is arranged as a timeline, and rearranging the clips changes the order in which the clips will be presented.

Users can create a custom media clip with or without the use of a template. A template guides the user in creating a custom media clip by enforcing one or more parameters. In some embodiments, a template limits the user in where a presented media clip may be used. For example, the user may only be able to select a Title clip or an Introductory Voice Over clip as a first clip. In some embodiments, if a user attempts to use a presented media clip in an area where it doesn't belong, an error message informs the user that the media clip cannot be used in that area and/or informs the user where the media clip can be used. A template typically enables a user to create a custom media clip with less effort than without a template.

A user can also create a custom media clip without the use of a template. When a template is not used, presented media clips may be used in any, or nearly any, order. Whether or not a template is used, the Player Maker may include a “Start Over” button or similar selection that allows the user to erase their progress and begin again.

In addition, the user can customize a title screen. In some embodiments, a list of words is presented to the user for selection, while in other embodiments, the user can input his or her own title.

After the user has created a custom media clip, the Player Maker allows the user to view the custom media clip. In addition, the user can save the custom media clip to his or her personal collection, whether hosted by the portal or locally available on the user's computer or mobile device. Alternatively or additionally, the user can post the custom media clip to the portal website, where it can be viewed by other users. In some embodiments, users vote for their favorite trailers. A vote may occur on a periodic basis, such as daily, weekly, or monthly.

In some embodiments, the presented media clips and the custom media clip are hosted and processed by the portal as streaming media. That is, no media is downloaded to the user during the process. In other embodiments, the presented media clips and/or the custom media clip may be downloaded to the user.

In some embodiments, the Player Maker can be branded and used by a third-party. For example, a third-party can use the Player Maker on their own web site to conduct a “make your own commercial” contest. The third-party can provide the Player Maker to users with or without a fee.

6. Points Redemption

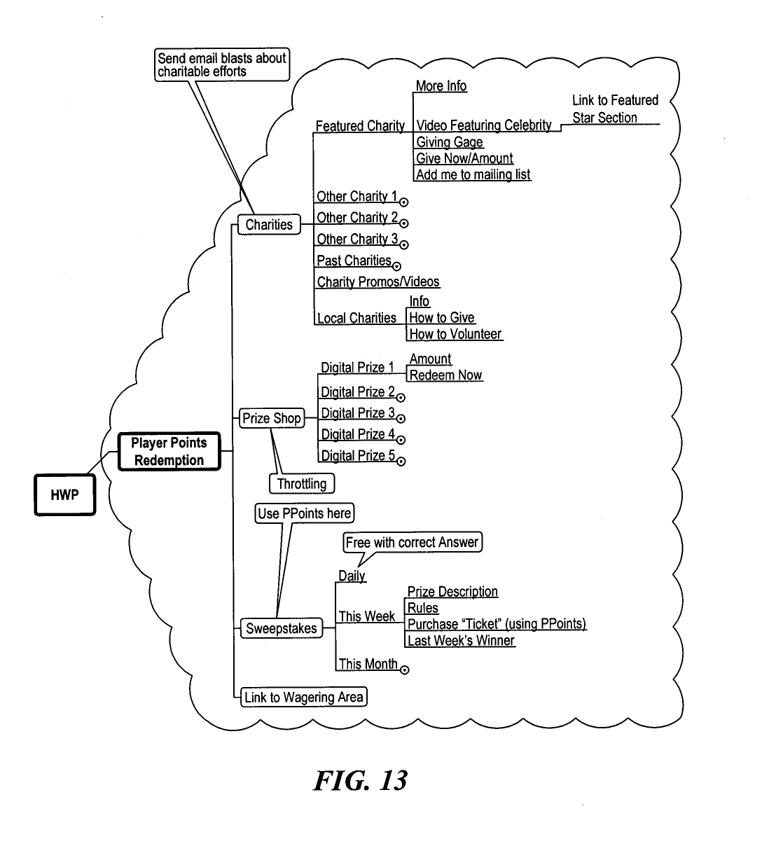

A Points Redemption area allows players to donate earned points (referred to herein as “PlayerPoints”) to charities, redeem PlayerPoints for prizes, enter a sweepstakes, and/or redeem PlayerPoints in other ways. FIG. 13 is a schematic diagram of embodiments of the Points Redemption area.

The Points Redemption area includes a Charitable Donation section. This section features one or more charities, including enabling a user to obtain more information about a featured charity. For example, the section may provide links that direct the user to a featured actor/actress's page that includes information about the featured charity. In some cases, the actor/actress appears in a video associated with the featured charity.

In some embodiments, the Charitable Donation section includes a measurement, such as a “Giving Gauge,” for the featured charity that illustrates how much money has been raised for that charity. Alternatively or additionally, the user can add his or her home address, email address, and/or other contact information to the featured charity's mailing list for future mailings and fundraising opportunities.

In addition, the Charitable Donation section provides information about charities in the user's local area. This section enables the user to obtain more information about local charities, donate directly to local charities, and find out how to volunteer for local charities.

The charities featured in the Charitable Donation section can change on a periodic basis, such as daily, weekly, or monthly. A user can still view and access information about non-featured charities, and these charities will still be able to receive donations. For example, non-featured charities can be accessed by selecting a link to “Other Charities,” “Past Charities,” or another link.

The Points Redemption also includes a Prize Shop that allows users to redeem PlayerPoints for prizes. The available prizes can include digital prizes, such as music, movie, and television show downloads. These downloads can be provided by third parties and/or the portal. Digital prizes can also include coupons for third party subscription services, such as Netflix, iTunes, magazines, and other subscriptions. Such coupons may provide new customers for the third parties, and can provide an additional revenue stream to the portal owner.

In addition, digital prizes can include downloads of ringtones, movie and TV clips, and other media to a user's computer and/or mobile device. Digital prizes can also include the option to send a media clip to a friend. For example, a user can send a romantic media clip to his girlfriend for Valentine's Day.

Alternatively or additionally, a user can purchase virtual items to be included on the user's Home Star, profile, and/or a virtual world offered by the portal or a third party service provider.

The Points Redemption Area also includes a Sweepstakes section that allows users to redeem their PlayerPoints for a sweepstakes entry. For example, a user can redeem a certain number of PlayerPoints for a ticket to be used in a raffle drawing. The number of PlayerPoints required for an entry and the number of entries allowed can vary depending on the sweepstakes prize, the length of time the raffle is available, and other factors.

Sweepstakes prizes may include a trip to see a TV show, such as the finale of a reality show (e.g., American Idol, Survivor, or Dancing With the Stars). Sweepstakes prizes may also include a trip to an awards show (e.g., the Oscars or the Grammy's), or an electronic device (e.g., Nintendo Wii, Microsoft Xbox 360, or an Apple iPhone).

The Sweepstakes section can also include a daily, weekly, and/or monthly sweepstakes drawing. In some embodiments, a user needs to correctly answer a displayed question in order to be entered in the daily, weekly, and/or monthly drawing. Alternatively or additionally, the Sweepstakes section can include prize descriptions, rules for sweepstakes entry, number of points required for entry, a listing of past winners, and other information.

7. Player Arcade

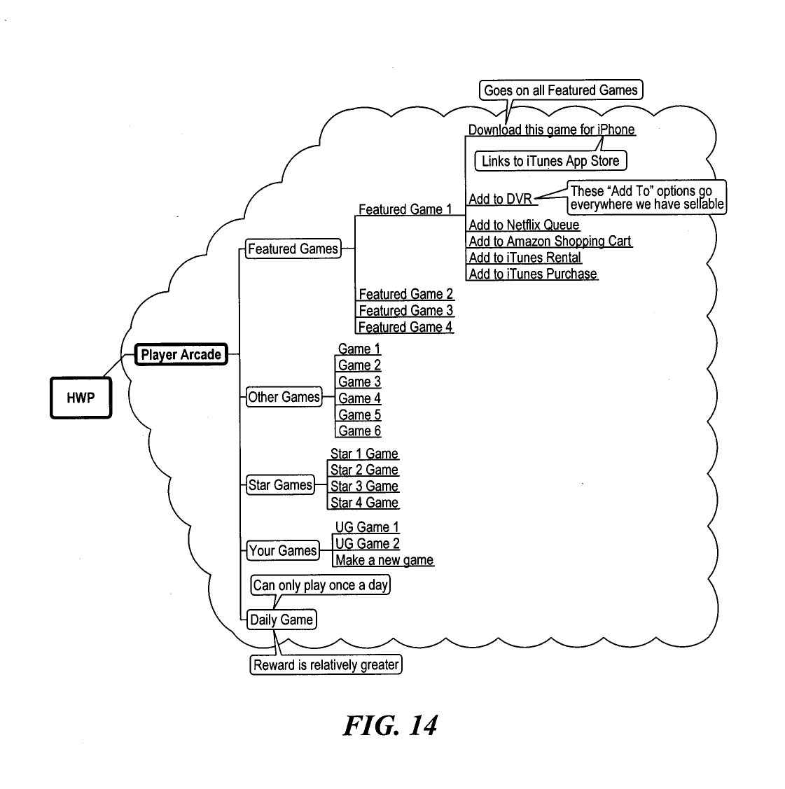

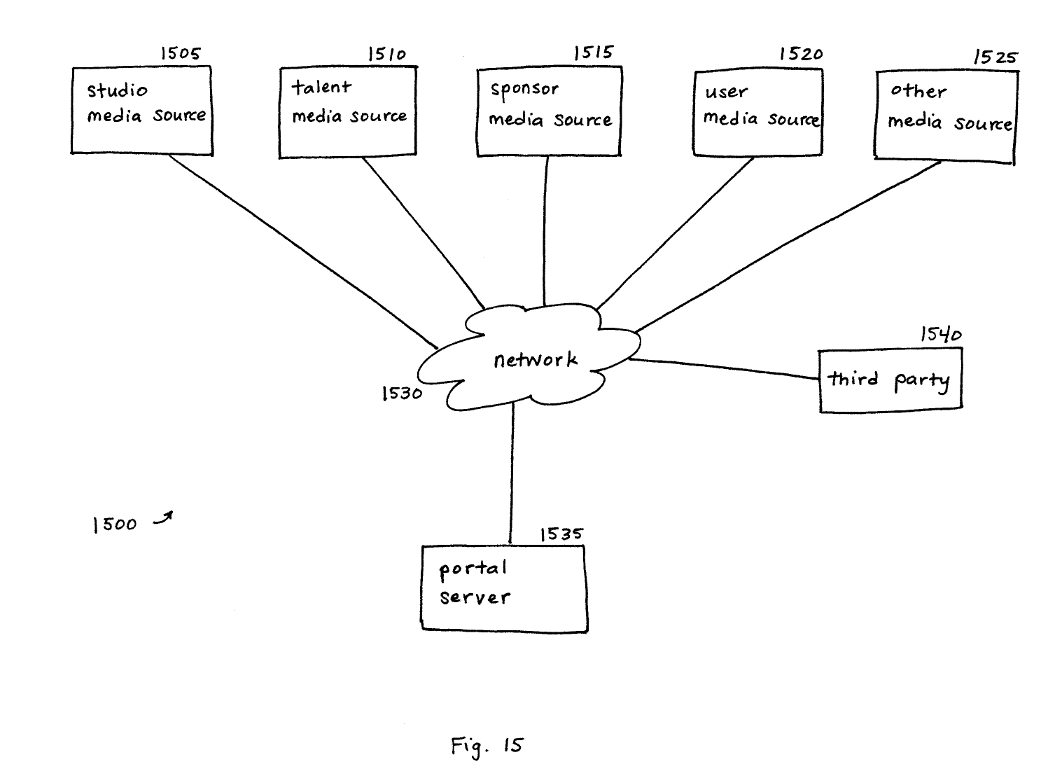

The Player Arcade includes a variety of casual games for users to play. Each game incorporates one or more media items. FIG. 14 is a schematic diagram of embodiments of the Player Arcade. In some embodiments, the Player Arcade includes a Main Arcade web page that features one or more games. In addition, the Main Arcade web page provides access to the entire library of games. These games include new games and common games (e.g., Concentration, Slingo, Whack-a-mole) that feature portal content.

The Player Arcade can include a variety of games, including, but not limited to:
Tag It—guess the movie, TV show, or other media clip from a slowly-revealed list of metatags, or keywords, used to describe the media clip;
Grab Tag—select the correct metatags, or keywords, that accurately describe a given movie, TV show, or other content, as the metatags float by;
Media Storm—guess the name of the movie, TV show, or other media clip from visual clues that are revealed by lightning flashes amidst a storm of other visual media;
Prop Master—choose the correct prop that is missing from the scene;
Costume Designer—choose the correct costume that is missing from the scene;
Hollywood Slingo—combination of Bingo and Slots;
Hollywood Cubes (i.e., Movie Cubes)—spin individual three-dimensional cubes within a grid so that all cubes correctly reveal a complete movie, TV, or other media scene;
Hollywood Concentration (i.e., Movie Match Up)—reminiscent of the classic matching game;
Well Connected—find a certain number of (e.g., 6) “connected” movie posters, images, and other media clips from presented media;
Cutting Room Floor—be a film editor, and correctly select the next shot in the movie or other media clip;
Movie Jigsaws (i.e., JigScene)—put a jigsaw puzzle together to create a complete movie, TV, or other media scene, while the puzzle pieces contain images and/or video that is continuously looped;
What's Different (i.e., Double Exposure)—select the things that are different between two still images or video clips;
Hollywood Hidden Object—find all the objects hidden in a still image or video clip, reminiscent of “Where's Waldo”;
Hollywood HotSpot—select certain items while a media clip plays;
Dialogue Ping Pong—complete a famous movie, TV, or other media scene by selecting the correct lines in the right order;
Movie Clip Poker/Password—guess a film from a still image, or foil your opponent by choosing the most obscure image clues to present to him/her;
Spot Watch—watch an entertaining commercial and answer questions about it;
Ad Cubes—similar to Hollywood Cubes, described above;
Ad HotSpot—similar to Hollywood HotSpot, described above;
Logo Concentration—similar to Hollywood Concentration, described above;
Pop-a-Razzi—earn points by avoiding the paparazzi and whacking them as they appear before their flash goes off;
Talent Torso—line up body parts correctly to create a complete actor or actress;
Star Matcher—similar to Hollywood Concentration, described above;
Star Tag—similar to Tag It, described above;
Star Jigsaws—similar to Movie Jigsaws, described above;
Star Cubes—similar to Hollywood Cubes, described above;
YouCube—similar to Hollywood Cubes, described above;
YouConcentrate (i.e., GameYourself Match Up)—similar to Hollywood Concentration, described above;
YouTag—similar to Tag It, described above;
YouPuzzle (i.e., GameYourself JigScene)—similar to Movie Jigsaws, described above; and
Other games.

The games in the Player Arcade can be single- and/or multi-player games. For example, multi-player games can include, but are not limited to, Dialogue Ping Pong, Movie Clip Poker/Password, and other games.

Games in the Player Arcade use similar user interface features and conventions where appropriate. For example, multiple games may include questions with multiple choice answers, instead of requiring direct text entry. Among other benefits, standard user interface features are easily deployed on multiple platforms and provide users with a similar experience across different games.

In some embodiments, game points earned while playing arcade games are converted to PlayerPoints. Game points may be converted to PlayerPoints using a conversion metric, algorithm, equation, or other mechanism. For example, 100 game points may be equivalent to 1 PlayerPoint.

In some embodiments, a portal server tracks the games played by a user, and the content displayed to the user during those games. Accordingly, the portal server can ensure that the new content is displayed to the user on a periodic basis, such as after a certain number of games.

a. Media-Based Casual Games

FIG. 15 is a block diagram of a suitable system for generating a game incorporating media from one or more media sources. Media may be provided from a variety of media sources, including, but not limited to, one or more TV and movie studios 1505, talent (i.e., actors and/or actresses) 1510, sponsors (i.e., advertisers) 1515, the user him- or herself 1520, and other media sources 1525. For example, a movie studio may provide video clips, still images, and/or other content; an actor and/or actress may provide video clips, still images, and/or other content; a sponsor may provide advertisements, logos, commercials, and/or other content; and a user may provide videos, photos, and/or other content that include the user and/or his friends and family. Each one of these media sources is an independent entity from the game producer and/or portal producer.

In some embodiments, media is transmitted from a media source 1505-25 to a portal server 1535 via a network 1530. Alternatively or additionally, an identifier associated with the media is transmitted from the media source 1505-25 to the portal server 1535 via the network 1530. Where only an identifier is transmitted, the portal server can use this identifier to access and stream the associated media as part of the game presentation.

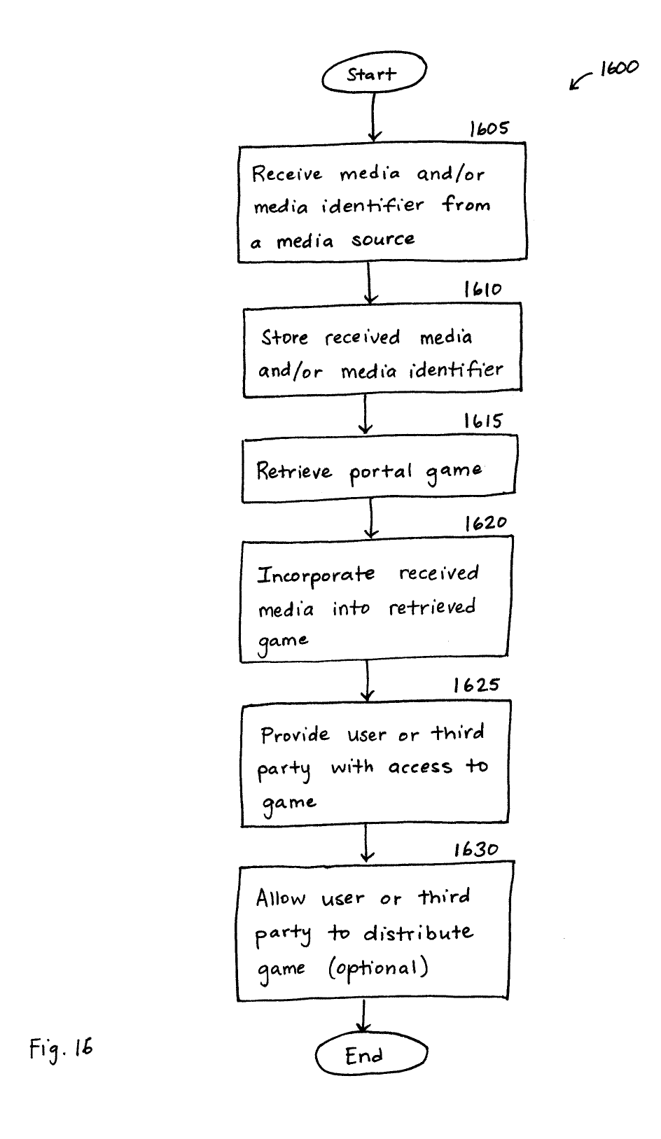

FIG. 16 is a flow diagram depicting a suitable process by which a portal game engine generates a game incorporating media from one or more media sources. As described above in reference to FIG. 15, at a block 1605 the game engine receives media and/or a media identifier from a media source, such as a studio, talent, sponsor, user, or other media source. At a block 1610, the game engine stores the received media and/or media identifier in a database coupled to the portal server.

In some embodiments, the game engine resides on a portal server. For example, the game engine may be accessed through a web address associated with the portal. In such embodiments, the game engine is served to the user's computer and/or mobile device each time that a game is played. In other embodiments, the game engine resides locally on the user's computer and/or mobile device. In some embodiments, such a game engine requires authentication of a valid software license.

At a block 1615, the portal server retrieves a portal game into which the received media is to be incorporated. The game can be retrieved from a database coupled to the portal server, a remote database, a third party, or another source.

At a block 1620, the portal server incorporates the received media into the retrieved game. The media may be incorporated into the game in a variety of manners. For example, the game may contain one or more placeholders for media items. When media and/or media identifiers are received, the portal server may insert the media and/or media identifier (e.g., a pointer to the media) into the corresponding placeholder. One skilled in the art will appreciate that a variety of other techniques may be used to incorporate media into the game.

Once the media has been incorporated into the game, at a block 1625, the portal server provides a user or a third party with access to the game. In some embodiments, the game is hosted by the portal server and is accessible by a user, a third party, and/or third party users via a web browser, social network, Internet-enabled mobile phone, game console, set-top or cable box, or in another manner. As discussed in additional detail herein, a user may need to be logged in to the portal in order to access the game, in addition to other portal content. Alternatively or additionally, the game may be downloaded by the portal server to the user's, third party's, and or third party user's computer and/or mobile device. A user may be required to accept Terms of Use or a license agreement in order to play the game.

Optionally, at a block 1630, the portal server may allow a user or third party to distribute the game to another user and/or third party. For example, when a game has been downloaded to a user's or third party's computer and/or mobile device, the portal server may permit the user or third party to send the game via email, provide the game for download, and/or share or distribute the game in another manner. As another example, when a game is hosted by the portal server, a user or third party may be permitted to send a link to the hosted game to another user and/or third party. The portal server may require that a user accept Terms of Use or a license agreement in order to play a received and/or hosted game.

Some of the games available in the Player Arcade will be described in detail herein, for purposes of illustration. Details of other games can be found, for example, in U.S. Patent Application Nos. 61/224,022, 61/252,615, and 61/265,342 to which this application claims priority and the disclosures of which are incorporated by reference herein. One skilled in the art will appreciate that a variety of other games are possible, and the technology is not limited to the particular games described.

b. User-Generated Media-Based Casual Games

Media-based casual games include games that incorporate user-generated media. These user-generated media-based casual games are versions of Player Arcade games that utilize user-generated video, still images, audio, and other media. These games may be presented under the “GameYourself” brand.

In some embodiments, a portal game engine alters the underlying user-generated media, while in other embodiments the game engine does not fundamentally alter the underlying media. In such embodiments, the game engine provides an alternate method of viewing the user-generated media, without circumventing copy protection or digital rights management. In addition, in some embodiments, the creation and/or playback of a user-generated media-based casual game requires acceptance of portal site terms of use. For example, the user may be required to confirm he has the rights to use the media, completely indemnify the portal site owner for the use of any personal or licensed media, and/or make other representations before creating or playing back a game.

User-generated media includes personal media, licensed media, and/or other media. Personal media includes personal photos, video, and/or other media that are local to the user's computer or mobile device. In addition, personal media includes personal photos, video, and/or other media that exist on a server repository accessible via the Internet or another network. Such repositories include those offered by services such as Flickr, Facebook, YouTube, and other services.

Licensed media includes any form of media to which the user has a license. As discussed above, in some embodiments, the game engine preserves copy-protection and digital rights management schema. In such embodiments, it is the user's responsibility to ensure that all rights are complied with, and that all appropriate rights citations are included.

As described above, in some embodiments, the game engine resides on a portal server. For example, the game engine may be accessed through a web address associated with the portal. In such embodiments, the game engine is served to the user's computer and/or mobile device each time that a game is played. In some embodiments, the game engine is enabled to use both media that resides on the portal server and media that resides on locally on the user's computer and/or mobile device.

In other embodiments, the game engine resides locally on the user's computer and/or mobile device. In some embodiments, such a game engine requires authentication of a valid software license. As with the server resident game engine, in some embodiments, the locally resident game engine is enabled to use both media that resides on the portal server and media that resides locally on the user's computer and/or mobile device.

Media-based casual games that incorporate user-generated media can be generated using a variety of processes, including that depicted by FIG. 16 and described herein. Once a game has been generated, it may be distributed to a user through a variety of means. In those embodiments in which the game engine resides on a portal server, a game can be access through any Internet-enabled client platform. For example, a game may be accessed by a user by navigating to a specific or custom URL for the game, a portal web page, a social network, or other site. The game may be accessed via a web browser, computer, mobile phone, game console, set-top or cable box, and/or in another manner.

In those embodiments in which the game engine is locally resident on a user's computer and/or mobile device, the game can be distributed directly or independently by a user. For example, the user may email the game or a link to the downloadable game to another user. In some embodiments, game distribution and/or playback requires acceptance of portal terms of use or a license agreement.

c. Hollywood Cubes

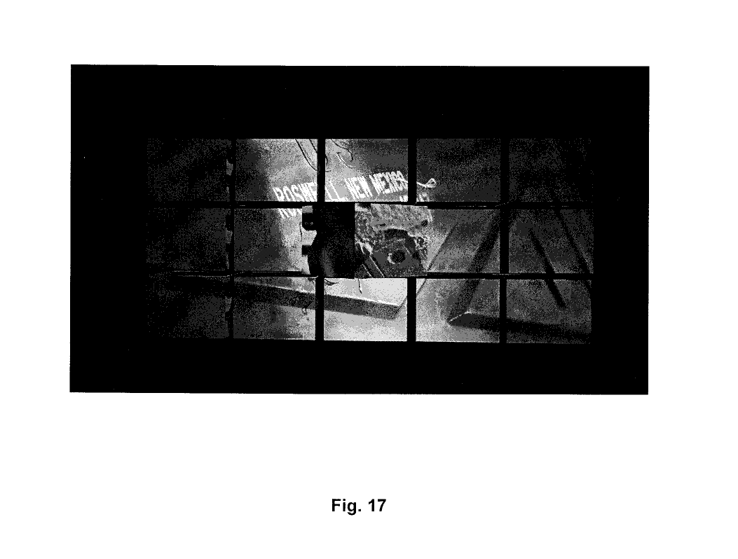

As discussed above, the Player Arcade can include a Hollywood Cubes game, in which an object is to spin individual three-dimensional cubes within a grid so that all cubes correctly reveal a complete movie, TV, or other media scene. Each side of a cube displays a portion of a still image, video, or other media that makes up the scene. The content for the cubes may include any of the sources noted above, such as user-generated content of six different digital photos. FIG. 17 is a display diagram that depicts embodiments of the Hollywood Cubes game.

In the Hollywood Cubes game, a grid of individual cubes is presented to the user. In the example depicted in FIG. 17, the grid comprises three rows of five cubes each (i.e., 3×5), for a total of fifteen cubes. One skilled in the art will appreciate that a variety of other grid sizes are possible, and that an arrangement of cubes may be in a format other than a grid, such as a particular shape or a free form arrangement. When the cubes are properly arranged within the grid, they make up a movie, TV, or other media scene. In some embodiments, each cube spins in a single direction (i.e., horizontally or vertically), while in other embodiments, each cube spins in both directions (i.e., horizontally and vertically).

Play begins with the cubes randomly, pseudo-randomly, or otherwise spun. A player selects (e.g., clicks on) an individual cube in order to manipulate that cube. In some embodiments, selecting an individual cube appears to “pull” that cube out of the grid, so that it appears larger than the other cubes and/or closer to the user. Once a cube has been selected, the user can spin the cube until a desired side of the cube is facing the user. Once the desired side of the cube faces the user, the user can “push” the cube back into its position in the grid.

In some embodiments, a user completes multiple scenes in a single Hollywood Cubes game. For example, in embodiments in which the cubes move in a single direction (e.g., horizontally or vertically), each cube may contain part of a scene for four different scenes. Once the cubes have been arranged within the grid to properly display a first scene, the user moves on to complete the other three scenes. Once all four scenes have been complete, the portal server displays a payoff media clip or trailer that includes the scenes or images completed by the user.

Hollywood Cubes and other games may be played at a variety of different skill or experience levels, such as beginning and advanced levels. For example, a beginning level for Hollywood Cubes may begin the game with all cubes in the right position within the grid; the cubes just need to be spun to display the correct side. Alternatively or additionally, the beginning level may include displaying still images on the cubes, instead of video. An advanced level for Hollywood Cubes may begin the game with cubes in incorrect positions within the grid; the cubes need to be spun to display the correct side and moved into the correct position within the grid. Alternatively or additionally, the advanced level may include displaying video or a continuous loop of still images, instead of static still images.

In some embodiments, a cube and/or an entire scene may display a logo or an advertisement for a sponsor. Among other benefits, the ability to display a logo or advertisement allows the portal owner to generate revenue while providing content to users.

d. Hollywood Concentration

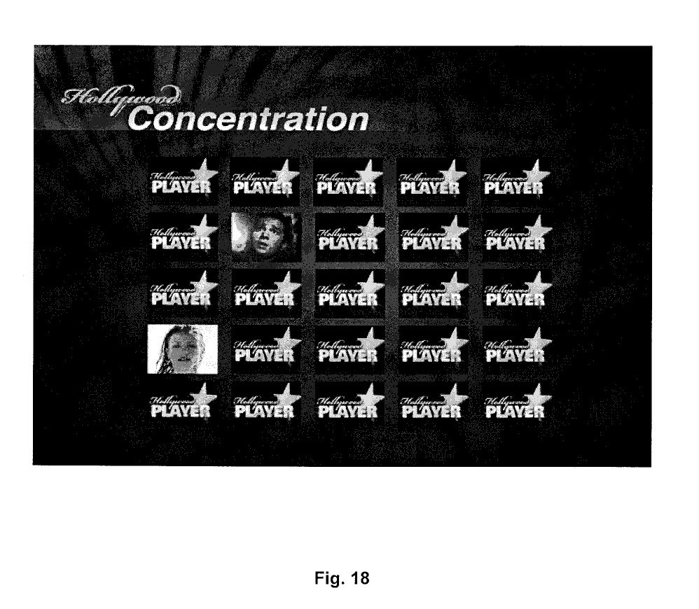

As described above, the Player Arcade can also include a Hollywood Concentration game reminiscent of the classic matching game. FIG. 18 is a display diagram that depicts embodiments of the Hollywood Concentration game.

Play begins with a grid of “cards” presented to the user in a face-down manner. In the example depicted in FIG. 18, the grid comprises five rows of six cards each (i.e., 5×6), for a total of twenty-five cards. One skilled in the art will appreciate that a variety of other grid sizes are possible, and that an arrangement of cards may be in a format other than a grid, such as a particular shape or a free form arrangement.

A user selects a first card to reveal a first still image, video, or other media on the other side of the first card. The user then selects a second card to reveal a second still image, video, or other media on the other side of the second card. If the media displayed on the first and second cards match, the both cards are removed from display, left on the display in their face-up position, or otherwise marked as a match. On the other hand, if the media displayed on the first and second cards do not match, both cards are turned back to their face-down position. The user must remember what media was displayed by the cards in order to make future matches. In some embodiments, a user is awarded more points the faster the user clears the board (i.e., matches all pairs of cards).

In some embodiments, the user can select a theme for the Hollywood Concentration game to be played. For example, the user may select a particular media genre (e.g., Science Fiction), actor or actress (e.g., Tom Hanks), or other category for the game.

Like other games, Hollywood Concentration may be played at a variety of different skill or experience levels. For example, as skill level increases, the grid size may also increase. Different skill levels may also involve different types of matching. For example, a beginning level may use the same image for a pair of matching cards, while an advanced level may use different images (e.g., same actor but different movies; or same movie but different actors or images) for a pair of matching cards. Alternatively or additionally, the beginning level may include displaying still images on the cards, while the advanced level may include displaying video or a continuous loop of still images on the cards.

### C. Conclusion

In general, the detailed description of embodiments of the described technology is not intended to be exhaustive or to limit the described technology to the precise form disclosed above. While specific embodiments of, and examples for, the technology are described above for illustrative purposes, various equivalent modifications are possible within the scope of the described technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the described technology may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the described technology may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the described technology reside on a server computer, while corresponding portions reside on a client computer such as a mobile or portable device, and thus, while certain hardware platforms are described herein, aspects of the described technology are equally applicable to nodes on a network.

The teachings of the described technology provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the described technology can be modified, if necessary, to employ the systems, functions, and concepts of the various references described above to provide yet further embodiments of the described technology.

These and other changes can be made to the described technology in light of the above Detailed Description. While the above description details certain embodiments of the described technology and describes the best mode contemplated, no matter how detailed the above appears in text, the described technology can be practiced in many ways. Details of the described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the described technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

I/We claim:

1. A method of incorporating user-generated media into a casual game, the method comprising:
receiving by a computer system user-generated media,
wherein the user-generated media includes digital images or digital video clips;
retrieving by the computer system a casual game from an associated game database,
wherein the casual game has relatively straightforward rules and is playable within a relative short period of time, as compared to a hardcore game having multiple, complex rules and a extensive game play over multiple levels, and
wherein a desired result under the rules of the casual game is achievable in under 15 minutes;
generating by the computer system a composite game, wherein the composite game is generated by incorporating the user-generated media into the retrieved game; and
providing a user with access to the generated composite game.

2. The method of claim 1 wherein the generated composite game is hosted by the computer system.

3. The method of claim 1 wherein the providing the user with access comprises downloading the generated composite game to a computer or mobile device of the user.

4. The method of claim 1 wherein the providing the user with access comprises requiring the user to be logged in to the system in order to play the generated composite game.

5. The method of claim 1 wherein the method further comprises enabling the user to distribute the composite game to another user.

6. A computer-readable storage medium storing instructions that, if executed by a computer system, cause the computer system to perform operations comprising:
receiving by the computer system user-generated media,
wherein the user-generated media includes digital images or digital video clips;
retrieving by the computer system a casual game from an associated game database,
wherein a desired result under the rules of the casual game is achievable in under 15 minutes;
generating by the computer system a composite game,
wherein the composite game is generated by incorporating the user-generated media into the retrieved game; and
providing a user with access to the generated composite game.

7. The computer-readable storage medium of claim 6 wherein the generated composite game is hosted by the computer system.

8. The computer-readable storage medium of claim 6 wherein the providing the user with access comprises downloading the generated composite game to a computer or mobile device of the user.

9. The computer-readable storage medium of claim 6 wherein the providing the user with access comprises requiring the user to be logged in to the system in order to play the generated composite game.

10. The computer-readable storage medium of claim 6, the operations further comprising:
enabling the user to distribute the composite game to another user.

11. The computer-readable storage medium of claim 10 wherein the user is enabled to distribute the generated media-integrated game by email or download.

12. The computer-readable storage medium of claim 6, the operations further comprising:
permitting the user to send a link to the composite game to another user or third party.

13. A computing system comprising:
a component configured to receive user-generated media,
wherein the user-generated media includes digital images or digital video clips;
a component configured to retrieve a casual game from an associated game database,
wherein the casual game has relatively straightforward rules and is playable within a relatively short period of time, as compared to a hardcore game having multiple, complex rules and a extensive game play over multiple levels, and
wherein a desired result under the rules of the casual game is achievable in under 15 minutes;
a component configured to generate a composite game, wherein the composite game is generated by incorporating the user-generated media into the retrieved game; and
a component configured to provide a user with access to the generated composite game.

14. The computing system of claim 13 wherein the generated composite game is hosted by the computer system.

15. The computing system of claim 13 wherein the component configured to provide the user with access comprises a component configured to download the generated composite game to a computer or mobile device of the user.

16. The computing system of claim 13 wherein the component configured to provide the user with access comprises a component configured to require the user to be logged in to the system in order to play the generated composite game.

17. The computing system of claim 13, further comprising:
a component configured to enable the user to distribute the composite game to another user.

18. The computing system of claim 13 wherein the component configured to enable the user is configured to enable the user to distribute the generated media-integrated game by email or download.

19. The computing system of claim 13, further comprising:
a component configured to permit the user to send a link to the composite game to another user or third party.

20. The computing system of claim 13 wherein an object of the composite game is to spin individual cubes within a grid so that each individual cube correctly reveals a complete media scene.
